(19) United States
(12) Patent Application Publication
(10) Pub. No.: US 2025/0173808 A1
(43) Pub. Date: May 29, 2025

(54) SYSTEMS AND METHODS FOR AUTOMATIC IDENTIFICATION OF VETERAN STATUS

(71) Applicant: Wells Fargo Bank, N.A., San Francisco, CA (US)

(72) Inventors: Justin Blackburn, Litchfield Park, AZ (US); Brent Finnell, Charlotte, NC (US); Walter Nelson Broadhurst, IV, Charlotte, NC (US); Danny Mathon, Charlotte, NC (US)

(21) Appl. No.: 18/521,626

(22) Filed: Nov. 28, 2023

(51) Int. Cl. G06Q 50/26; G06Q 10/1057; H04L 67/306

(52) U.S. Cl. CPC G06Q 50/265; G06Q 10/1057; H04L 67/306

(57) ABSTRACT

Systems, apparatuses, methods, and computer program products are disclosed for automatic identification of veteran status. An example method includes extracting user data from a data environment. The example method further includes determining a user attribute set comprising one or more user attributes, each associated with a user data type. The example method further includes generating an aggregated veteran likelihood score based on an analysis of the one or more user attributes. The example method further includes assigning a veteran status classification based on the aggregated veteran likelihood score, and providing a verification prompt requesting the user to verify the assigned veteran status classification.

### BACKGROUND

Military veterans may be eligible for various programs and benefits. To access said programs and benefits, veterans may need to provide proof of their service. This oftentimes requires veterans to self-identify and manually provide necessary information.

### BRIEF SUMMARY

The implementation of software technologies for identification of user characteristics has become increasingly important to establishments, particularly in the context of delivering services or programs to customers that are contingent upon specific aspects of the customer profile. While these systems serve as a safeguard ensuring that users accessing services meet the requisite eligibility criteria, the full extent and applications of identification software technologies are still being explored.

Veterans in the United States are eligible for a wide range of benefits as a result of their military service. These benefits are provided by the Department of Veteran Affairs (VA) and other government agencies. Some common benefits offered to veterans include healthcare, disability compensation, education, pension, employment assistance, home loans, life insurance, tax exemptions, etc. Eligibility for these benefits can vary based on factors such as the length and nature of a veteran's service, discharge status, and disability ratings. However, as current practices for veteran status identification rely primarily on self-declaration, establishments that provide veteran benefits are unable to reach all eligible users, potentially denying benefits to those who qualify due to the manual nature of the veteran status identification process. As such, these establishments inadvertently create inequities in access to benefits for those who are less informed. In addition, handling self-declaration forms and manually verifying veteran status can also be an administratively burdensome process that can cause delays in processing and potential backlogs, impose challenges in ensuring compliance with changing eligibility criteria or regulations, increase susceptibility to errors or fraudulent claims, result in misclassification of eligibility, and/or undermine the integrity of veteran benefit programs. There is a unique need for a technical solution that (i) functions independently of any manual activity of a user, (ii) can systematically identify the veteran status of a user, and (iii) reliably presents a user with qualifying veteran-specific benefits that are offered by an establishment. A complex solution of this nature requires a systematic and computer-based implementation. Accordingly, there exists an underlying technical necessity for systems that are able to autonomously provide this capability.

Example implementations described herein provide a technical solution to this technical problem. Moreover, example embodiments overcome the challenges that arise by requiring users to manually self-declare their veteran status, and prevent financial losses incurred by missed opportunities. Example embodiments described herein use an automatic veteran identification system including veteran status predictive classification model. In response to the detection of a user visit event at an establishment, the veteran identification system assigns a veteran status classification to the user and provides the user with a verification prompt requesting the user to verify the assigned veteran status classification. Further, example embodiments iteratively train the veteran status predictive classification model. This allows the model to learn from past misclassifications, adjust its parameters for improved performance, and expedite status classification for users, significantly reducing processing time. In addition, example embodiments described herein may be used to design automated systems that protect veterans' privacy by securely handling sensitive information. Further, an establishment that offers a multitude of benefits for veterans may use example embodiments described herein to enhance outreach by proactively identifying eligible veterans and ensuring quicker delivery of benefits and services, regardless of their self-declaration status. Establishments may also directly benefit from resource optimization, wherein veteran-specific services would be directed to those who truly qualify, which can be cost-efficient.

In one example embodiment, a method is provided for automatic identification of veteran status. The method includes extracting, by a smart engine and using a veteran status predictive classification model, user data from a data environment. The method further includes determining, by the smart engine and using the veteran status predictive classification model, a user attribute set, wherein (i) the user attribute set comprises one or more user attributes and (ii) each user attribute is associated with a user data type. The method further includes generating, by the smart engine and using the veteran status predictive classification model, an aggregated veteran likelihood score, wherein the aggregated veteran likelihood score is based on an analysis of the one or more user attributes from the user attribute set. The method further includes assigning, by the smart engine and using the veteran status predictive classification model, a veteran status classification to the user based on the aggregated veteran likelihood score generated, and providing, by communications hardware and based on the assigned veteran status classification, a verification prompt, wherein the verification prompt requests the user to verify the assigned veteran status classification.

In another example embodiment, an apparatus is provided for automatic identification of veteran status. The apparatus includes a smart engine configured to extract, using a veteran status predictive classification model, user data from a data environment. The smart engine is further configured to determine, using the veteran status predictive classification model, a user attribute set, wherein (i) the user attribute set comprises one or more user attributes and (ii) each user attribute is associated with a user data type. The smart engine is further configured to generate, using the veteran status predictive classification model, an aggregated veteran likelihood score, wherein the aggregated veteran likelihood score is based on an analysis of one or more user attributes from the user attribute set. The smart engine is further configured to assign, using the veteran status predictive classification model, a veteran status classification to the user based on the aggregated veteran likelihood score generated. The apparatus further includes communications hardware configured to provide, based on the assigned veteran status classification, a verification prompt, wherein the verification prompt requests the user to verify the assigned veteran status classification.

In another example embodiment, a computer program product is provided for automatic identification of veteran status. The computer program product includes at least one non-transitory computer readable storage medium storing software instructions that, when executed, cause an apparatus to extract, using a veteran status predictive classification model, user data from a data environment. The at least one non-transitory computer-readable storage medium storing software instructions that, when executed, further cause an apparatus to determine, using the veteran status predictive classification model, a user attribute set, wherein (i) the user attribute set comprises one or more user attributes and (ii) each user attribute is associated with a user data type. The at least one non-transitory computer-readable storage medium storing software instructions that, when executed, further cause an apparatus to generate, using the veteran status predictive classification model, an aggregated veteran likelihood score, wherein the aggregated veteran likelihood score is based on an analysis of one or more user attributes from the user attribute set. The at least one non-transitory computer-readable storage medium storing software instructions that, when executed, further cause an apparatus to assign, using the veteran status predictive classification model, a veteran status classification to the user based on the aggregated veteran likelihood score generated, and provide, based on the assigned veteran status classification, a verification prompt, wherein the verification prompt requests the user to verify the assigned veteran status classification.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for automatic identification of veteran status.

FIG. 2 illustrates a schematic block diagram of example circuitry embodying a system device that may perform various operations in accordance with some example embodiments described herein.

FIG. 3 illustrates an example flowchart for automatic identification of veteran status, in accordance with some example embodiments described herein.

FIG. 4 illustrates an example flowchart for assigning a veteran status classification to a user, in accordance with some example embodiments described herein.

FIG. 5A illustrates an example flowchart for providing a verification prompt requesting a user to verify the assigned veteran status classification, in accordance with some example embodiments described herein.

FIG. 5B illustrates an example flowchart for providing a verification prompt requesting an affiliate user to verify the assigned familial veteran status classification, in accordance with some example embodiments described herein.

FIG. 6 illustrates an example flowchart for training a veteran status predictive classification model, in accordance with some example embodiments described herein.

FIG. 7 illustrates a schematic block diagram of a veteran likelihood score generation framework.

FIG. 8 illustrates an example user interface illustrating a veteran status confirmation request used in some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “data environment” may refer to any collection of distinct spaces or contexts where data may be stored, processed, and managed. In some embodiments, a data environment may be accessed to retrieve user data.

The term “user data” may refer to any information or personal data associated with a user, such as identity information, contact information, financial information, online activity, in-person visits, communication history, authentication data, device information, consent records, and/or the like. In some embodiments, the user data may be extracted from a data environment in response to detecting a user visit event at an establishment.

The term “veteran status predictive classification model” may refer to a machine learning or predictive analytics model designed to automatically determine whether an individual is a veteran or not based certain user attributes. In some embodiments, the veteran status predictive classification model may assign users to one of three veteran status classifications: “veteran”, “non-veteran”, “affiliate-veteran”. In some embodiments, the veteran status predictive classification model may assign an identified veteran a sub-classification based on their discharge status: “veteran—honorable discharge”, “veteran—dishonorable discharge”, “veteran—medically discharged”.

The term “user attribute set” may refer to a collection or group of specific characteristics, traits, or data points associated with an individual user within a system, application, or database. These attributes provide detailed information about the user, allowing establishments to better understand, categorize, and personalize interactions or services. In some embodiments, the user attribute set may comprise attributes such as veteran status and/or non-veteran status indicators comprising demographic information, contact information, account information, behavioral data, authentication data, health data, social media profiles, custom attributes, and/or the like.

The term “user data type” may refer to a structured format or classification within a software or database system that between different formats and/or values of user attribute data. A user data type may include a branch of service data type, a date of service data type, a discharge type data type, a veteran identification number data type, a military award and decoration data type, a VA benefits enrollment data type, a prior self-declaration of veteran status data type, a military occupational specialty data type, a service-related disability data type, a membership in veteran organization data type, a military ID card data type, a military forms data type, a military pension or retirement benefit data type, a deployment history data type, a G.I. bill usage data type, a veteran status in employment data type, a financial data type, an address history data type, a medical history data type, or a familial relationship data type.

The term “aggregated veteran likelihood score” may refer to a numerical value or rating that summarizes the probability or likelihood that a user is a veteran based on various user attributes. In some embodiments, the aggregated veteran likelihood score may be calculated by analyzing and aggregating a multitude of attributes associated with a user.

The term “verification prompt” may refer to a message or communication issued by an establishment that is designed to request the user's confirmation or verification of the assigned veteran status classification, to ensure accurate eligibility determination for veteran status opportunities.

The term “predefined veteran likelihood threshold” may refer to a predetermined and specific numerical value or probability level used to make decisions or classifications regarding an individual's veteran status. In some embodiments, the threshold value may be expressed as a percentage or numerical range that qualifies a user for veteran-specific opportunities, ranging from 0% (very unlikely to be a veteran) to 100% (very likely to be a veteran).

The term “veteran status indicator” may refer to a piece of information or a marker used to signify or indicate an individual's veteran status classification. In some embodiments, the veteran status indicator may be included in records, profiles, or databases associated with users and used by establishments to recognize and categorize users who have served in the military.

The term “per-veteran status indicator veteran likelihood score” may refer to a specialized score or probability value assigned to a particular veteran status indicator. In some embodiments, the per-veteran status indicator veteran likelihood score may be expressed as a percentage or numerical value and may be determined through data-driven methods, which may involve analyzing factors such as military service history, age, demographics, and/or the like.

The term “veteran status opportunity” may refer to a benefit or offer where an individual's veteran status can be leveraged for advantages associated with being identified as a veteran.

The term “verification response” may refer to a user's reply or action taken in response to the provided verification prompt. In some embodiments, the user may confirm or deny their assigned veteran status classification and indicate their acknowledgement and verification of being a “veteran”, “non-veteran”, “affiliate user—veteran”, “affiliate user—non-veteran”.

The term “verification evidence” may refer to the supporting documentation or proof that may be required to authenticate a user's verification response to the verification prompt. In some embodiments, the verification evidence may comprise tangible or digital evidence that substantiates the user's claim regarding their veteran status classification, such as documentation (e.g., discharge papers such as a DD Form 214, military ID cards, relevant certificates) and/or the like.

The term “authenticity score” may refer to a numerical or qualitative assessment of the likelihood that the provided verification evidence is genuine and has not been altered or tampered with. In some embodiments, the authenticity score may be calculated and/or assigned by establishments as a part of the verification process to ensure the credibility and legitimacy of the submitted verification evidence.

The term “predefined authenticity score threshold” may refer to a specific numerical value or qualitative level set by establishments as the minimum authenticity score that the verification evidence must achieve to be considered authentic and valid.

The term “affiliate user” may refer to an individual linked to a user through a qualifying familial relationship. In some embodiments, affiliate users may include family members, dependents, or individuals with a designated connection to the user. In some embodiments, affiliate users may have limited or controlled access within the system and/or may inherit certain settings or permissions from the user.

The term “familial veteran status classification” may refer to a categorization or classification system used to identify and acknowledge the veteran status of users based on their familial relationships with a veteran.

The term “predictive classification accuracy” may refer to the measurement of how effectively a predictive classification model correctly assigns veteran status classification to users. In some embodiments, the predictive classification accuracy quantifies the veteran status predictive classification model's ability to make accurate predictions when assigning veteran status classifications to users.

### System Architecture

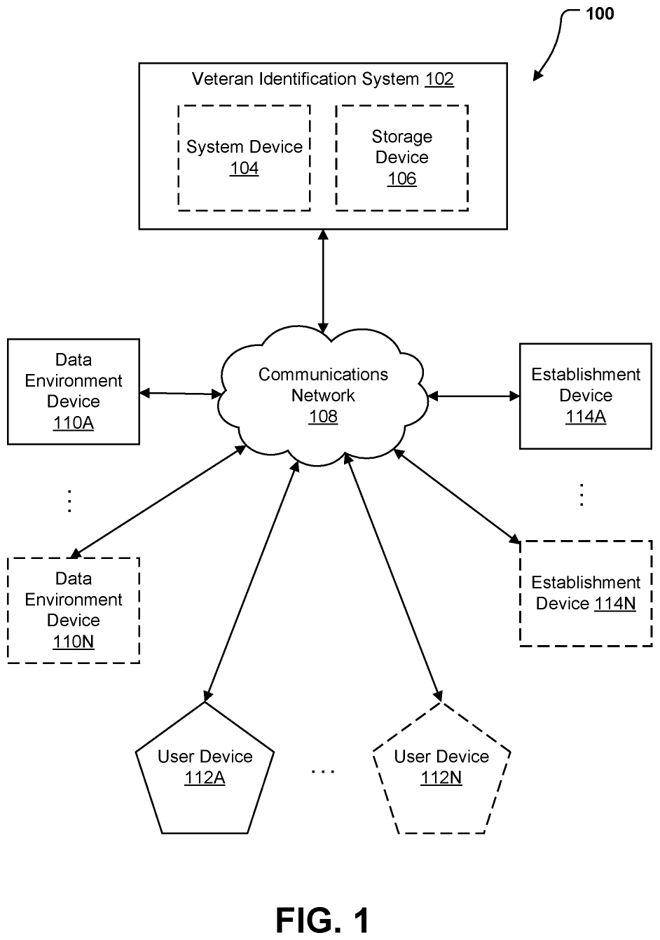

Example embodiments described herein may be implemented using any of a variety of computing devices or servers. To this end, FIG. 1 illustrates an example environment 100 within which various embodiments may operate. As illustrated, a veteran identification system 102 may include a system device 104 in communication with a storage device 106. Although system device 104 and storage device 106 are described in singular form, some embodiments may utilize more than one system device 104, more than one storage device 106, and/or the like. Some embodiments of the veteran identification system 102 may not require a system device 104 and/or storage device 106 at all. Whatever the implementation, the veteran identification system 102 may receive and/or transmit information via communications network 108 (e.g., the Internet) with any number of other devices, such as one or more of data environment devices 110A-110N, user devices 112A-112N, and/or establishment devices 114A-114N. A data environment device 110A-110N may include RFID, Bluetooth devices, security cameras, whereas an establishment device 114A-114N may be a device associated with an establishment that stores data for the establishment.

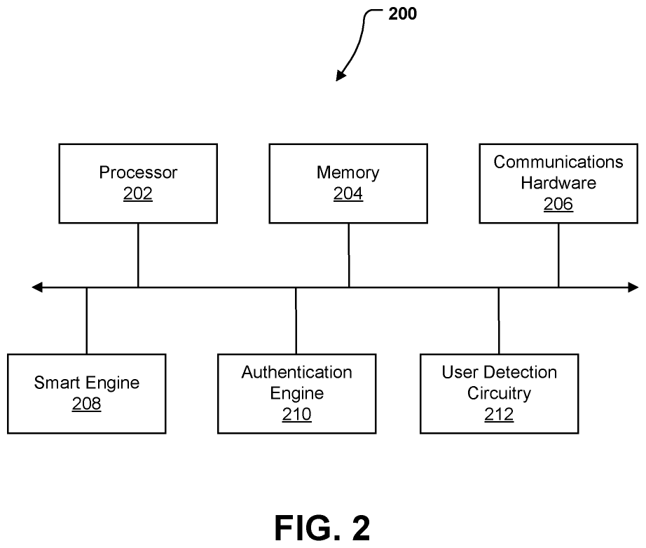

In some embodiments, the veteran identification system 102 may be implemented as one or more computing devices or servers, which may be composed of a series of components. These components of system device 104 may be physically proximate to the other components of the veteran identification system 102 while other components are not. The system device 104 may receive, process, generate, and transmit data, signals, and electronic information to facilitate the operations of the veteran identification system 102. Particular components of the veteran identification system 102 are described in greater detail below with reference to apparatus 200 in connection with FIG. 2.

In some embodiments, the veteran identification system 102 further includes a storage device 106 that comprises a distinct component from other components of the veteran identification system 102. Storage device 106 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 108). Storage device 106 may host the software executed to operate the veteran identification system 102. Storage device 106 may store information relied upon during operation of the veteran identification system 102, such as various user data that may be used by the veteran identification system 102, data and documents to be analyzed using the veteran identification system 102, or the like. In addition, storage device 106 may store control signals, device characteristics, and access credentials enabling interaction between the veteran identification system 102 and one or more of the data environment devices 110A-110N, user devices 112A-112N, and/or establishment devices 114A-114N.

The one or more data environment devices 110A-110N, user devices 112A-112N, and/or establishment devices 114A-114N may be embodied by any computing devices known in the art, such as computers, laptops, servers, etc. The one or more data environment devices 110A-110N, user devices 112A-112N, and/or establishment devices 114A-114N need not themselves be independent devices, but may be peripheral devices communicatively coupled to other computing devices.

Although FIG. 1 illustrates an environment and implementation in which the veteran identification system 102 interacts directly with a user via one or more of user devices 112A-112N (e.g., via communications hardware of the veteran identification system 102), in which case a separate establishment device 114A-114N may not be utilized. Whether by way of direct interaction or indirect interaction via another device, a user may communicate with, operate, control, modify, or otherwise interact with the veteran identification system 102 to perform the various functions and achieve the various benefits described herein.

### Example Implementing Apparatuses

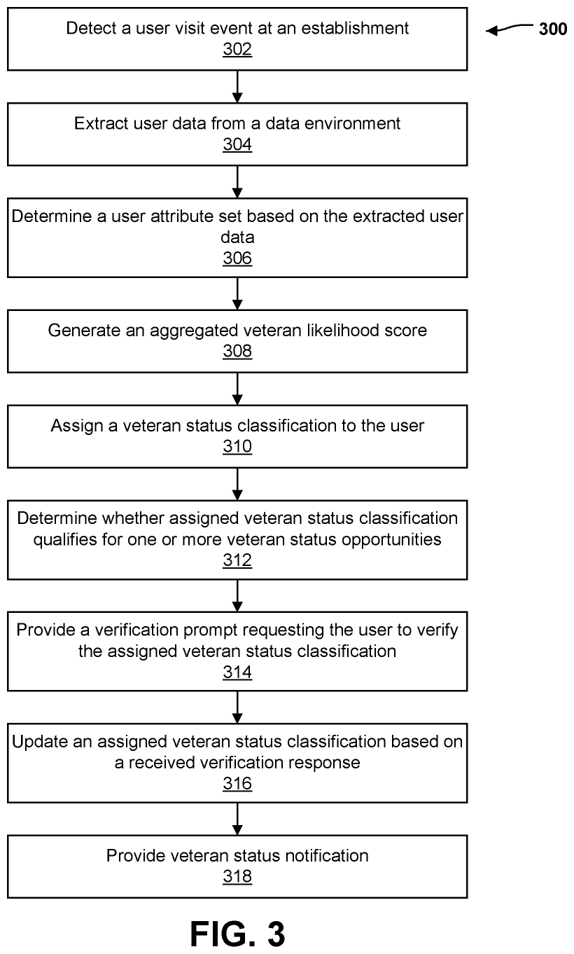

The veteran identification system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-8. As illustrated in FIG. 2, the apparatus 200 may include processor 202, memory 204, communications hardware 206, smart engine 208, authentication engine 210, and user detection circuitry 212, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

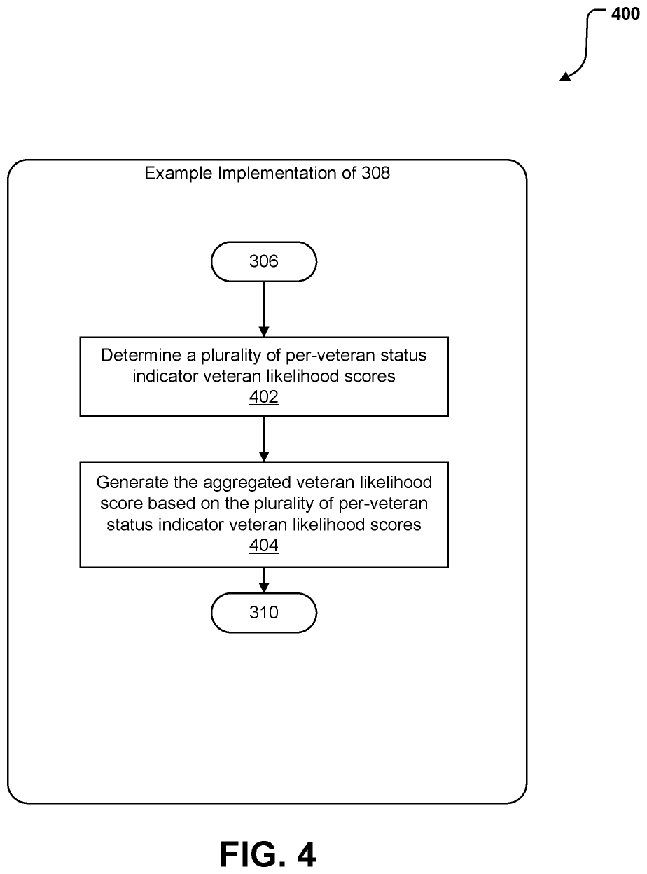

In addition, the apparatus 200 further comprises a smart engine 208 that extracts user data from a data environment. In some embodiments, the smart engine 208 may be configured to determine a user attribute set based on the extracted user data, generate an aggregated veteran likelihood score, assign a veteran status classification to a user, and update a veteran status of the user to the assigned veteran status classification. The smart engine 208 may utilize processor 202, memory 204, or any other hardware component included in the apparatus 200 to perform these operations, as described in connection with FIGS. 3-4 below. The smart engine 208 may further utilize communications hardware 206 to extract user data from a variety of sources (e.g., data environment device 110A-110N or storage device 106, as shown in FIG. 1), and/or exchange data with a user, and in some embodiments may utilize processor 202 and/or memory 204 to analyze a plurality of veteran status indicators from the extracted user data, determine a plurality of per-veteran status indicator veteran likelihood scores, and determine whether the veteran status classification assigned to the user qualifies for the at least one veteran status opportunity offered by an establishment.

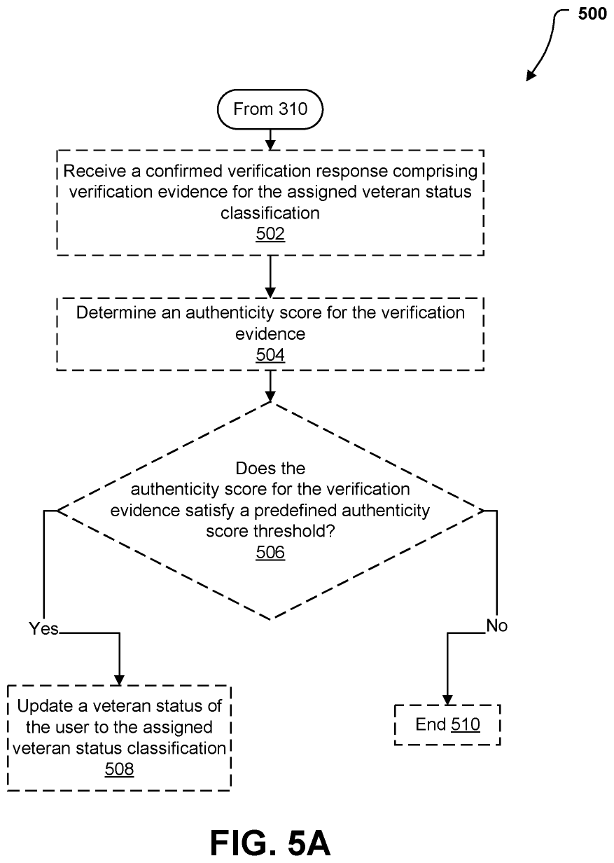

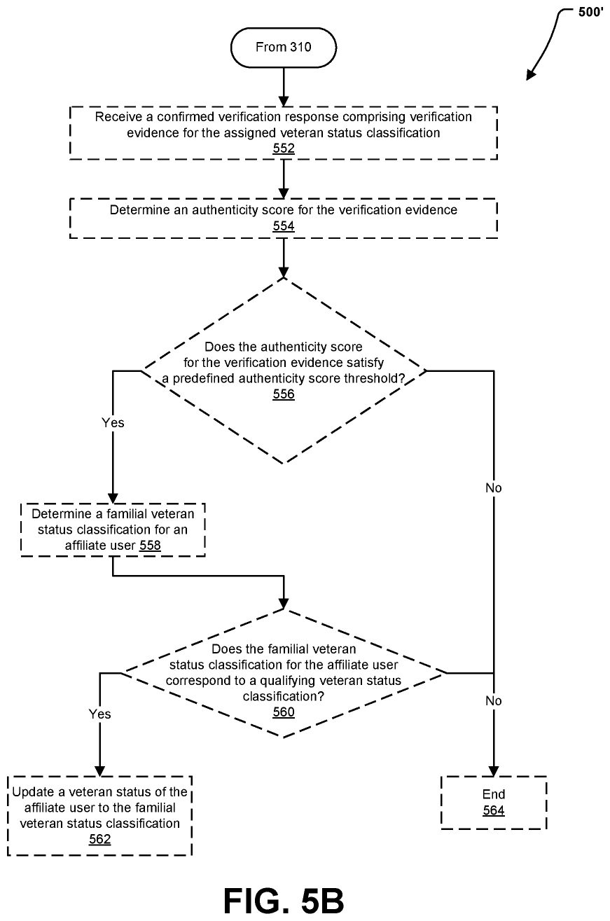

In addition, the apparatus 200 further comprises an authentication engine 210 that determines an authenticity score for the verification evidence. The authentication engine 210 may utilize processor 202, memory 204, or any other hardware component included in the apparatus 200 to perform these operations, as described in connection with FIGS. 5A-5B below. The authentication engine 210 may further utilize communications hardware 206 to receive the verification evidence from the user device 112A-112N, and in some embodiments, may utilize processor 202 and/or memory 204 to determine whether the authenticity score for the verification evidence satisfies a predefined authenticity score threshold.

In addition, the apparatus 200 further comprises user detection circuitry 212 that detect a user visit event at an establishment. The user detection circuitry 212 may utilize processor 202, memory 204, or any other hardware component included in the apparatus 200 to perform these operations, as described in connection with FIG. 4 below.

Although components 202-212 are described in part using functional language, it will be understood that the particular implementations necessarily include the use of particular hardware. It should also be understood that certain of these components 202-212 may include similar or common hardware. For example, the smart engine 208, authentication engine 210, and user detection circuitry 212 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the smart engine 208, authentication engine 210, and user detection circuitry 212 may leverage processor 202, memory 204, or communications hardware 206 as described above, it will be understood that any of smart engine 208, authentication engine 210, and user detection circuitry 212 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that smart engine 208, authentication engine 210, and user detection circuitry 212 comprise particular machinery designed for performing the functions described herein in connection with such elements of apparatus 200.

In some embodiments, various components of the apparatuses 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatuses 200, example embodiments are described below in connection with a series of flowcharts, schematic block diagrams, and graphical user interfaces.

### Example Operations

Turning to FIGS. 3-7, example flowcharts and schematic block diagrams are illustrated that contain example operations implemented by example embodiments described herein. The operations illustrated in FIGS. 3-7 may, for example, be performed by system device 104 of the veteran identification system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, smart engine 208, authentication engine 210, user detection circuitry 212, and/or any combination thereof. It will be understood that user interaction with the veteran identification system 102 may occur directly via communications hardware 206, or may instead be facilitated by a separate user device 112A-112N, as shown in FIG. 1, and which may have similar or equivalent physical componentry facilitating such user interaction.

Turning first to FIG. 3, a procedure 300 illustrates example operations for automatically identifying veteran status of a user. By automatically identifying veteran status of a user, an establishment that is associated with a veteran status opportunity may provide a benefit where an individual's veteran status can be leveraged for advantages associated with being identified as a veteran. For example, the establishment may offer discounts on certain items or enrollment into a special program for users who are veterans or family of veterans.

As shown by operation 302, the apparatus 200 includes means, such as processor 202, memory 204, communications hardware 206, smart engine 208, or the like for detecting a user visit event at an establishment. A user visit event may refer to a specific occurrence or interaction where a user engages with the physical location or digital platform of an establishment. In some embodiments, the establishment may be associated with at least one veteran status opportunity. In some embodiments, once the smart engine 208 detects a user visit, as described below, the smart engine 208 may determine whether the establishment is associated with at least one veteran status opportunity. In some embodiments, an establishment database may be maintained in an associated memory, such as memory 204, and may include one or more establishment profiles. Each establishment profile may uniquely correspond to a particular establishment and may include the one or more veteran status opportunities offered by said establishment. In some embodiments, communications hardware 206 may receive an indication of the one or more veteran status opportunities and smart engine 208 may update the establishment profile of the corresponding establishment to include the provided veteran status opportunities. Alternatively, smart engine 208 may use tools, such as web-crawlers, optical character recognition techniques, natural language processing techniques and/or the like to identify veteran status opportunities from external sources (e.g., a verified webpage of the establishment) and automatically update the establishment profile to include the veteran status opportunities.

In order to detect a user visit event at an establishment, the smart engine 208 may analyze various data to determine the establishment and further, the type of user visit event. In some embodiments, the user visit event is a physical user visit event. Physical visit detection at an establishment may use communications hardware 206 to transmit or receive signals from a user device (e.g., any one of user devices 112A-112N), in combination with technologies like Wi-Fi, Bluetooth beacons, or RFID tags to track user devices within a specific range of the establishment location. Alternatively, the user visit event may be a digital visit event. In contrast to physical visit events, the communications hardware 206 may use web analytics and tracking tools for digital visit detection.

In example embodiments, smart engine 208 may analyze the signal strength and proximity of user devices to determine whether a user is physically inside an establishment or may process hypertext transfer protocol (HTTP) logs and web analytics to identify digital user visits. Further, the smart engine 208 may classify the user visit event as a physical or digital visit based on the data source and context, and may also sub-categorize the visit event by identifying new users to the establishment versus returning users who have previously visited the establishment. In example embodiments, smart engine 208 may also interpret the processed data to differentiate between visitor and non-visitor signals for a physical visit, and may also analyze page views, session data, and user interactions to identify digital visits. Memory 204 may temporarily store event data such as device identifier (IDs) and timestamps for physical visits and store session details or uniform resource locators (URLs) for digital visits.

The smart engine 208 may also be configured to respond to establishment requirements and trigger notifications or actions in response to a visit event (e.g., notifying a staff member of a physical visit or customizing content for a digital visit). In example embodiments, the smart engine 208 may respond to detected user visit events by extracting user data from a data environment, as described in further detail below.

As shown by operation 304, the apparatus 200 includes means, such as processor 202, memory 204, communications hardware 206, smart engine 208, user detection circuitry 212, or the like, for extracting user data from a data environment. The user detection circuitry 212 may access a memory, such as memory 204, to deploy a user data extraction algorithm that is configured to extract user data from a data environment. In some embodiments, the user data extraction algorithm may comprise a set of instructions that specify how to access, retrieve, and/or store user data. In example embodiments, the user data extraction algorithm may include parameters such as (i) data source locations (e.g., relational databases such as MySQL, cloud storage such as Google Cloud, API endpoints, file systems, social media platforms, etc.), (ii) data format specifications (e.g., javascript object notation (JSON), extensible markup language (XML), comma-separated values (CSV), database schema, etc.), (iii) extraction criteria (e.g., unique user identifiers, geographic location data, user profiles, transaction history, custom filters, etc.), and/or the like.

The user data may be collected and/or received from various devices, such as any one of data environment devices 110A-110N or user devices 112A-112N. In an instance in which a user re-visits an establishment, the user data (e.g., historical user data) may also be collected and/or received from any one of establishment devices 114A-114N storing data from the user's prior/historical visit. In example embodiments, the veteran status predictive classification model may also be used to determine the parameters relevant for extracting veteran status specific user data.

Via the communications hardware 206, the smart engine 208 may establish connections to the designated data sources (e.g., any one of data environment devices 110A-110N, user devices 112A-112N, and/or establishment devices 114A-114N) and authenticate itself to gain access to the data environment, ensuring compliance with security protocol and permissions. The smart engine 208 may query the data environment based on the defined extraction criteria and employ processor 202 to process the extracted data in real-time. Data processing by smart engine 208 may involve cleaning, transforming, and/or organizing the data for storage in memory 204. Upon completion of the extraction operation, the smart engine 208 may provide the extracted user data as input to the veteran status predictive classification model for further processing or analysis.

In some embodiments, the smart engine 208 may extract user data that includes one or more veteran status indicators. In some embodiments, the smart engine 208 may be configured to identify veteran status indicators within the user data and may extract such data. For example, the smart engine may use any suitable techniques such as NPL, OCR, or may further, use a pre-processing model, such as a neural network (e.g., a convolutional neural network) to identify veteran status indicators within the user data such that these veteran status indicators may be extracted. In some embodiments, the pre-processing model may be part of the veteran status predictive classification model. As will be appreciated, user data may include a variety of formats such that the user data may be unstructured. Thus, the pre-processing model may be configured to apply extraction techniques to said unstructured user data to extract useful, structured veteran status indicators.

In some embodiments, veteran status indicators may include values for one or more of a branch of service (e.g., Army, Navy, Air Force, Marines, National Guard or Reserves Services), dates of service (e.g., Mar. 20, 2019-Mar. 20, 2023), discharge type (e.g., honorable, general, dishonorable, medical), veteran identification number, military awards and decorations, veteran affairs (VA) benefits enrollment (e.g., education, healthcare, etc.), prior self-declaration of veteran status, military occupational specialty, service-related disabilities, membership in veteran organizations, military ID cards, military forms (e.g., a DD Form 214), military pension or retirement benefits, deployment history, G.I. bill usage, veteran status in employment, financial data, address history, medical history, or familial relationships etc.

As shown by operation 306, the apparatus 200 includes means, such as processor 202, memory 204, smart engine 208, or the like, for determining a user attribute set based on the extracted veteran status indicators. In some embodiments, the smart engine 208 may determine the user attribute set based on the extracted veteran status indicators. In particular, a user attribute set may include one or more user attributes and each user attribute may be associated with a user data type. In some embodiments, the smart engine 208 may include each veteran status indicator extracted in operation 304 as a user attribute and further, may determine a user data type for the user attribute.

The smart engine 208 may retrieve from memory 204 the extracted user data (e.g., veteran status indicators) and deploy a preprocessing function to ensure consistency and compatibility of the extracted user data with the veteran status predictive classification model. Furthermore, the preprocessing function may determine a user data type for a given veteran status indicator. In some embodiments, a user data type may include a branch of service data type, a date of service data type, a discharge type data type, a veteran identification number data type, a military award and decoration data type, a VA benefits enrollment data type, a prior self-declaration of veteran status data type, a military occupational specialty data type, a service-related disability data type, a membership in veteran organization data type, a military ID card data type, a military forms data type, a military pension or retirement benefit data type, a deployment history data type, a G.I. bill usage data type, a veteran status in employment data type, a financial data type, an address history data type, a medical history data type, or a familial relationship data type.

In some embodiments, only a subset of the veteran status indicators are included as user attributes in the user attribute set. For example, the smart engine 208 may only include veteran status indicators that correspond to a particular user data type. The veteran status indicators included in the user attribute set may be determined based on historical analyses performed by the veteran status predictive classification model. For example, the veteran status predictive classification model may store trained parameters indicative of a historical per-veteran status indicator veteran likelihood scores for a given user attribute type. The smart engine 208 may be configured to select only veteran status indicators associated with a user attribute type that is associated with a historical per-veteran status indicator veteran likelihood score that satisfies a threshold value. Thus, the veteran status predictive classification model may be used identify the veteran status indicators that are strongly correlated with veteran status.

In example embodiments, the smart engine 208 may enable the veteran status predictive classification model to perform feature engineering by accessing memory 204 to retrieve additional user data, if there are missing values for certain veteran status indicators. For example, a composite score may be calculated depending on both the total number of military awards received and the duration of military service. Further example embodiments may also involve the veteran status predictive classification model in performing a normalization function (e.g., min-max scaling, z-score standardization, etc.) to ensure that the user attributes are a part of the user attribute set are on a consistent scale.

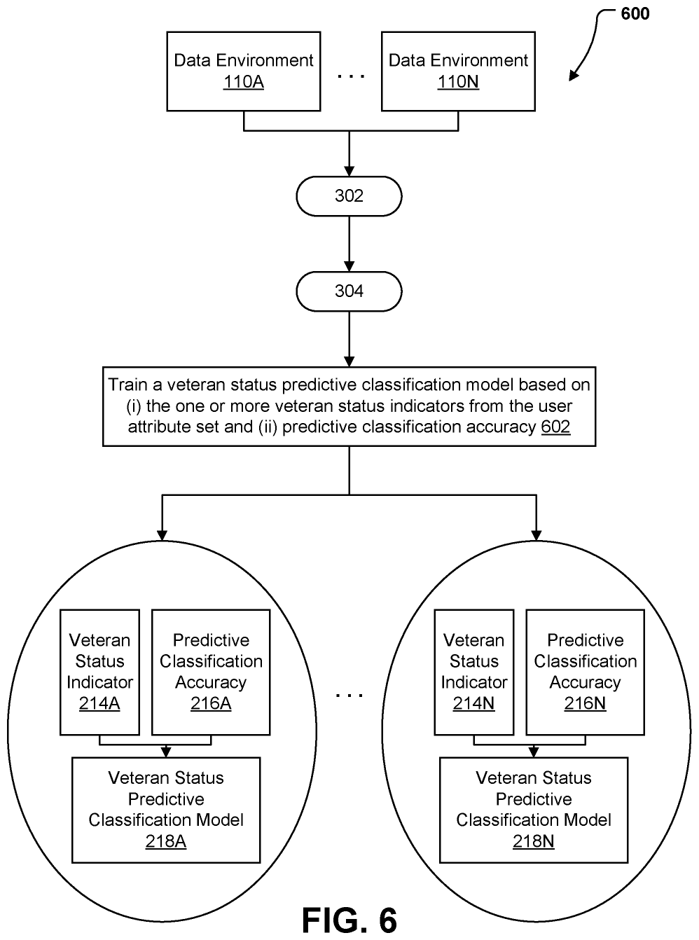

Turning now to FIG. 6, a procedure 600 illustrates example operations for training a veteran status predictive classification model 218A-218N. As shown by operation 602, the apparatus 200 includes means, such as smart engine 208, or the like, for training the veteran status predictive classification model 218A-218N using the veteran status indicators 214A-214N from the user attribute set(s) determined in operation 304. In example embodiments, model training may occur as follows: (i) data preprocessing wherein the smart engine 208 cleans and preprocesses the veteran status indicators from the user attribute set to handle any missing values, outliers, or data quality issues, (ii) feature engineering wherein the smart engine 208 may create or extract features from the user attribute set that may be relevant for predicting veteran status, (iii) splitting the data wherein the smart engine divides the engineered dataset into a training set and testing set, (iv) selecting an appropriate machine learning classification algorithm (e.g., logistic regression, decision trees, random forests, support vector machines, or neural networks), (v) training the selected classification model using the training data, (vi) evaluating the model's performance using the testing dataset using a predictive classification accuracy metric 216A-216N, (vii) fine-tuning the model's hyperparameters such as learning rate, regularization strength or tree depth, depending on the chosen algorithm to optimize its performance, (viii) performing k-fold cross-validation on the training data to assess the model's generalization performance to ensure that the model does not over fit the training data, (ix) analyze the importance of different features in predicting veteran status, and (x) choosing the best-performing model based on evaluation metrics and cross-validation results. For every user visit event, the smart engine 208 may gather and store the extracted user data in memory 204 for the iterative training of the veteran status predictive classification model.

Returning to FIG. 3, as shown by operation 308, the apparatus 200 includes means, such as processor 202, memory 204, smart engine 208, or the like, for generating an aggregated veteran likelihood score. The aggregated veteran likelihood score may be indicative of a likelihood or probably that the user is a veteran. The smart engine 208 may generate the aggregated veteran likelihood score based on an analysis of one or more user attributes from the user attribute set. In some embodiments, the smart engine 208 may be configured to use a veteran status predictive classification model to determine the aggregate veteran likelihood score. The smart engine 208 may provide the user attribute set as input to the veteran status predictive classification model to generate the aggregated veteran likelihood score for the user.

In some embodiments, operation 308 may be performed in accordance with the operations described by FIG. 4. Turning now to FIG. 4, a procedure 400 illustrates example operations for generating an aggregated veteran likelihood score.

As shown by operation 402, the apparatus 200 includes means, such as processor 202, memory 204, smart engine 208, or the like, for determining a plurality of per-veteran status indicator veteran likelihood scores. Each per-veteran status indicator veteran likelihood score may correspond to a particular user attribute of the user attribute set. In some embodiments, the smart engine 208 may provide the user attribute set as input to the veteran status predictive classification model and the veteran status predictive classification model may be configured to parse or identify each user attribute of the user attribute set and determined a per-veteran status indicator veteran likelihood score for each user attribute. In example embodiments, the veteran status predictive classification model may be configured to use logistic regression, or the like, to (i) assign a particular weight to each user attribute, and (ii) deploy an appropriate mathematical function to produce a per-veteran status indicator veteran likelihood score for each user attribute. Various techniques may be employed by the veteran status predictive classification model to perform this operation (e.g., decision trees, random forests, permutation importance, L1 regularization, correlation analysis, statistical tests). Each per-veteran status indicator veteran likelihood score may be representative of the influence of or importance of a user attribute in predicting the veteran status. In some embodiments, a per-veteran status indicator veteran likelihood score may be a numerical score, such as between 0 and 1, where 1 is indicative that the user attribute confirms that the user is a veteran and 0 is indicative that the user attribute provides no information about whether the user is a veteran.

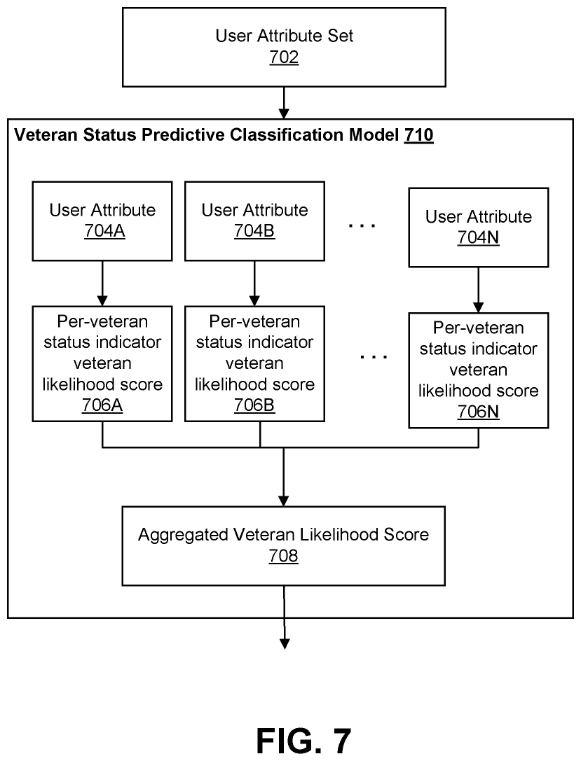

As shown by operation 404, the apparatus 200 includes means, such as processor 202, memory 204, smart engine 208, or the like, for generating the aggregated veteran likelihood score based on the plurality of per-veteran status indicator veteran likelihood scores. As described above, the smart engine 208 may use the veteran status predictive classification model to determine the plurality of per-veteran status indicator veteran likelihood score. In some embodiments, the smart engine 208 may further use the veteran status predictive classification model to generate the aggregated veteran likelihood score. In particular, the veteran status predictive classification model may be configured to weight each per-veteran status indicator veteran likelihood score based on the associated user attribute type. The weight applied to each per-veteran status indicator veteran likelihood score may be a determined during a training portion of the veteran status predictive classification model. The veteran status predictive classification model may then use aggregation techniques to determine the aggregated veteran likelihood score. For example, the veteran status predictive classification model may take the average of the weighted per-veteran status indicator veteran likelihood score. The smart engine 208 and veteran status predictive classification model may use a veteran likelihood score generation framework as displayed in FIG. 7 to generate an aggregated veteran likelihood score.

FIG. 7 illustrates a schematic block diagram illustrating an example operational flow 700 using an example the veteran status predictive classification model. As shown in in FIG. 7, a user attribute set 702 may be provided as input to the veteran status predictive classification model 710. The veteran status predictive classification model 710 may identify each user attribute within the user attribute set (e.g., user attributes 704A-704N) and determine corresponding per veteran status indicator veteran likelihood scores for each user attribute (e.g., per veteran status indicator veteran likelihood scores 706A-706N). The veteran status predictive classification model 710 may then generate the aggregated veteran likelihood score 708 based on the per veteran status indicator veteran likelihood scores 706A-706N and may output the aggregated veteran likelihood score 708.

Returning to FIG. 3, as shown by operation 310, the apparatus 200 includes means, such as smart engine 208, or the like, for assigning a veteran status classification to the user. In example embodiments, the smart engine 208 may compare the aggregated veteran likelihood score to a predefined threshold. A predefined threshold acts as a decision boundary and may be (i) a balanced threshold (e.g., threshold of 0.5 or 50% wherein if the model predicts a probability of 0.5 or higher, the user is classified as a veteran or otherwise classified as a non-veteran), (ii) high confidence threshold (e.g., threshold of 0.8 or 80% that ensures that only highly likely veteran status predictions are accepted), (iii) dynamic threshold that is adjusted based on real-time conditions or feedback, (iv) regulatory threshold that is set to meet compliance requirements, (v) customized threshold that is set to meet an establishment's requirements, etc. In addition, the predefined threshold value may be configured by one or more authorized users, such as an end user associated with an establishment that operates the veteran identification system 102. In example embodiments, if the aggregated veteran likelihood score satisfies the predefined threshold, the model may assign a veteran status classification of “veteran” or “affiliate user-veteran” to the user. In some embodiments, the model may assign a veteran status classification of “affiliate user-veteran” based on identifying user attributes that are indicative that the user is a family member (e.g., shared last name, shared address, common birthdays, marriage status, adoption records, mentions in legal documents, etc.). On the contrary, if the aggregated veteran likelihood score fails to satisfy the predefined threshold, the model may assign a veteran status classification of “non-veteran” to the user.

As shown by operation 314, the apparatus 200 includes means, such as memory 204, communications hardware 206, smart engine 208, or the like, for providing a verification prompt requesting the user to verify the assigned veteran status classification. In particular, the communications hardware 206 may provide the verification prompt to the user via one or more user devices 112A-112N using any suitable communication channel (e.g., text message, voice calls, via a corresponding mobile application, and/or the like) The smart engine 208 may retrieve a verification template stored in memory 204 for generating a verification prompt for specific scenarios. In instances where the user has been assigned a veteran status classification of “veteran”, “affiliate user-veteran”, or “non-veteran”, the verification prompt may populate the verification prompt accordingly, making it relevant and personalized for a particular user. The verification prompt may be formatted to ensure it is compatible for user device (e.g., any one of user devices 112A-112N) and appears in a user-friendly manner. This can involve HTML/CSS for web interfaces, text formatting for SMS messages, or rich formatting for mobile applications. In example embodiments, the verification prompt may include localization wherein the verification prompt is adapted to different languages, regions, or cultural norms based on user preferences or system settings of the user device 112A-112N. Accordingly, using communications hardware 206, the verification prompt may then be displayed to the user device 112A-112N through a web page, mobile app screen, email, text message, or any other channel used for user interaction.

As shown by operation 312, the apparatus 200 includes means, such as memory 204, communications hardware 206, smart engine 208, or the like, for determining qualifying offers for the user based on a veteran status classification. The smart engine 208 may compare the assigned veteran status classification against the criteria set by an establishment offering a veteran status opportunity. Eligibility criteria set by an establishment may comprise service duration, discharge status, or other factors. Upon performing a series of conditional checks against the establishment's eligibility criteria, the veteran status predictive classification model makes a decision about whether the user qualifies for the particular veteran status opportunity. This decision may be binary in nature (e.g., qualified or not qualified), or may involve multiple categories (e.g., qualified with certain benefits). By way of example, a retail store offers a discount to veterans and defines that only veterans with an “honorable discharge” status qualify for the discount. If the veteran status predictive classification model determines that the user's veteran status classification matches that of the establishment requirements, then the user would be identified as being qualified for the discount opportunity.

As shown by operation 314, the apparatus 200 includes means, such as memory 204, communications hardware 206, smart engine 208, or the like, for providing a verification prompt requesting the user to verify an assigned veteran status classification. In some embodiments, the verification prompt may include an indication of the assigned veteran status classification for the user as determined in operation 310. The verification prompt may further provide instructions for the user to confirm or deny the assigned veteran status classification. The communications hardware 206 may provide the verification prompt to any one of user devices 112A-112N.

As shown by operation 316, the apparatus 200 includes means, such as memory 204, communications hardware 206, smart engine 208, or the like, for updating an assigned veteran status classification based on a received verification response. The verification response may be received from any one of user devices 112A-112N in response to user input confirming, denying, or modifying the assigned veteran status classification included in the verification prompt.

In some embodiments, operation 316 may be performed in accordance with the operations described either FIG. 5A or FIG. 5B. FIGS. 5A-5B illustrate example operations for updating a veteran status based on a verification response. The process may proceed in accordance with the operations illustrated in FIG. 5A in an instance in which the verification response includes a “veteran” response from the user. Alternatively, the process may proceed in accordance with the operations illustrated in FIG. 5B in an instance in which the verification response is indicative of a self-declared familial relationship between the user (e.g., an affiliate user) and a veteran user.

Turning first to FIG. 5A, a procedure 500 illustrates example operations for updating a veteran status of the user to the assigned veteran status classification. As shown by operation 502, the apparatus 200 includes means, such as communications hardware 206, smart engine 208, authentication engine 210, or the like, for receiving a verification response comprising verification evidence for the assigned veteran status classification. In some embodiments, the verification response is indicative of a selection of a “veteran” status. Furthermore, the verification response may further include verification evidence. Verification evidence may include a DD Form 214 also known as a certificate of release or discharge from active duty, a veterans identification card (VIC), military service records, Department of Defense ID cards, veterans' health administration (VHA) health care enrollment letter, state veteran ID cards, a VA disability award letter, an American legion or VFW membership cards, military orders and certificates, other government-issued identification, etc.

As shown by operation 504, the apparatus 200 includes means, such as smart engine 208, authentication engine 210, or the like, for determining an authenticity score for the verification evidence. The authentication engine 210 is set up to receive incoming verification evidence securely and uses encryption and authentication mechanisms to establish a secure communication channel with the endpoint of smart engine 208. Upon receiving the verification evidence, the authentication engine 210 may decrypt the data to access the actual verification evidence provided by the user. In example embodiments, the authentication engine 210 may process the verification evidence using algorithms and methods based on a particular establishment's verification requirements. Example methods may include comparing documents to a reference document to confirm authenticity, analyzing biometric data, deploying classification models, etc., after which the authentication engine 210 may determine an authenticity score for the verification evidence.

As shown by operation 506, the apparatus 200 includes means, such as authentication engine 210, for determining whether the authenticity score for the verification evidence satisfies a predefined authenticity score threshold. In example embodiments, the authenticity score may be compared to the predefined threshold, wherein a score that is equal to or higher than the threshold is indicative of authentic verification evidence. An authenticity score that is lower than the threshold may be considered. Alternate rule-based systems with a set of rules or criteria may also be used to validate evidence. For example, if a user submits DD Form 214 as their verification evidence, the authentication engine 210 may check for watermarks or security features that are difficult to reproduce, as well as verify signatures from appropriate military personnel.

As shown by operation 508, the apparatus 200 includes means, such as smart engine 208, authentication engine 210, or the like, for updating a veteran status of the user to the assigned veteran status classification. The updated veteran status of the user, along with the submitted verification evidence may be stored in an associated user profile and/or user account for future user.

As shown by operation 510, the apparatus 200 includes means, such as smart engine 208, or the like, for ending the veteran identification system operation in an instance in which the authenticity score for the verification evidence does not satisfy a predefined authenticity score threshold. In this instance, the smart engine 208 may trigger a response requesting a customer service representative of the establishment to further inspect the situation.

In this instance, operations will accordingly follow FIG. 5A. If the user selects “affiliate user—veteran”, this is indicative of a self-declared familial relationship between the affiliate user and user, and operations may accordingly follow FIG. 5B.

Turning now to FIG. 5B, a procedure 500′ illustrates example operations for updating a veteran status of the affiliate user to the familial veteran status classification. As shown by example operation 552, the apparatus 200 includes means, such as communications hardware 206, smart engine 208, authentication engine 210, or the like, for receiving a verification response comprising verification evidence for the assigned veteran status classification. In some embodiments, the verification response is indicative of a selection of a “affiliate user—veteran” status. Furthermore, the verification response may further include verification evidence. The affiliate user may also provide additional verification evidence to establish authenticity of a qualifying familial relationship between themselves and the user who has been identified as a veteran. For this case, example verification evidence may comprise documentation such as marriage certificates, birth certifications, or other legal documents that demonstrate the familial relationship. In example embodiments, the user or affiliate user may submit verification evidence through the user interface on their user device 112A-112N that is received by the smart engine 208. To ensure the security and privacy of the verification evidence, the smart engine 208 may encrypt the verification evidence before transmission to ensure sensitive information is protected from unauthorized access during transit. The encrypted verification evidence may be transmitted to the authentication engine 210 over the internet using secure protocols such as HTTPS.

As shown by operation 554, the apparatus 200 includes means, such as smart engine 208, authentication engine 210, or the like, for determining an authenticity score for the verification evidence. The authentication engine 210 is set up to receive incoming verification evidence securely and uses encryption and authentication mechanisms to establish a secure communication channel with the endpoint of smart engine 208. Upon receiving the verification evidence, the authentication engine 210 may decrypt the data to access the actual verification evidence provided by the user. In example embodiments, the authentication engine 210 may process the verification evidence using algorithms and methods based on a particular establishment's verification requirements. Example methods may include comparing documents to a reference document to confirm authenticity, analyzing biometric data, deploying classification models, etc., after which the authentication engine 210 may determine an authenticity score for the verification evidence.

As shown by operation 556, the apparatus 200 includes means, such as authentication engine 210, for determining whether the authenticity score for the verification evidence satisfies a predefined authenticity score threshold. In example embodiments, the authenticity score may be compared to the predefined threshold, wherein a score that is equal to or higher than the threshold is indicative of authentic verification evidence. An authenticity score that is lower than the threshold may be considered. Alternate rule-based systems with a set of rules or criteria may also be used to validate evidence. For example, if a user submits DD Form 214 as their verification evidence, the authentication engine 210 may check for watermarks or security features that are difficult to reproduce, as well as verify signatures from appropriate military personnel.

As shown by operation 558, the apparatus 200 includes means, such as smart engine 208, for determining a familial veteran status classification for an affiliate user. The familial veteran status classification may include, but is not limited to, “affiliate—veteran (child), “affiliate—veteran (spouse), “affiliate—veteran (sibling)”, “affiliate—veteran (blood relative)”, “affiliate—veteran (adopted child)”, “affiliate—veteran (domestic partner)”, etc. The smart engine 208 may assign a familial veteran status classification to the affiliate user depending on the verification evidence submitted. For example, a submission of a marriage certificate reasonable indicates that the familial veteran status classification for the affiliate user should be “affiliate—veteran (spouse)”.

As shown by operation 560, the apparatus 200 includes means, such as smart engine 208, for determining whether the familial veteran status classification for the affiliate user corresponds to a qualifying veteran status classification. Depending on the rules or criteria set by an establishment for a particular veteran offer, the familial veteran status classification for the affiliate user may or may not qualify. For example, a bank may offer a mortgage loan special to the spouses of veterans. However, if the assigned veteran status classification is indicative of a relationship between a veteran and a child, then the affiliate user would not qualify for the offer in this case. In example embodiments, the smart engine 208, or the like, may perform a comparison analysis between the establishment's set of rules and criteria and the assigned familial veteran status classification to determine whether the affiliate user would qualify for the offer.

As shown by operation 562, the apparatus 200 includes means, such as smart engine 208, or the like, for updating the veteran status of the affiliate user to the familial veteran status classification. In an instance in which the affiliate user qualifies for a particular veteran opportunity, the smart engine 208, may update the veteran status of the affiliate user to the familial veteran status classification. The updated veteran status of the user, along with the submitted verification evidence may be stored in an associated user profile and/or user account for future user.

As shown by operation 564, the apparatus 200 includes means, such as smart engine 208, for ending the veteran identification system operation in an instance in which the familial veteran status classification for the affiliate user does not correspond to a qualifying veteran status classification. At this stage, the smart engine 208 may end the veteran identification system 102.

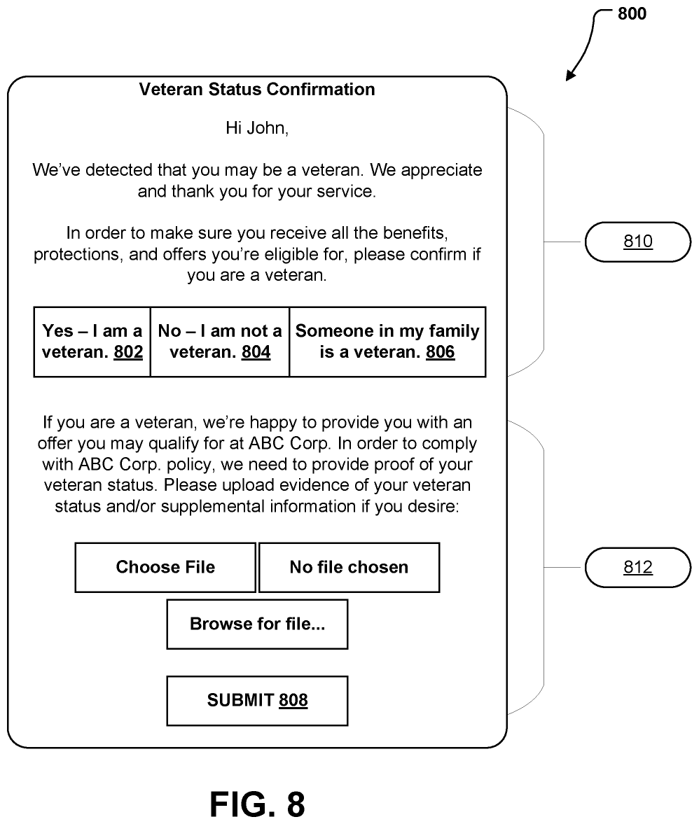

Turning to FIG. 8, a graphical user interface (GUI) is provided that illustrates an example verification prompt. As noted previously, a user may interact with the veteran identification system 102 by directly engaging with communications hardware 206 of an apparatus 200 comprising a system device of the veteran identification system 102. In such an embodiment, the GUI shown in FIG. 8 may be displayed to a user by the apparatus 200. Alternatively, a user may interact with the veteran identification system 102 using a separate user device (e.g., any of user devices 112A-112N as shown in FIG. 1), which may communicate with the veteran identification system 102 via communications network 108. In such an embodiment, the GUI shown in FIG. 8 may be displayed to the user by the user device 112A-112N.

As shown in FIG. 8, the verification prompt 800 may include confirmation options, 802-806, pertaining to the assigned veteran status confirmation. The verification prompt 800 may further include user interaction element 810 that allows the user to indicate their responses to communications hardware 206 as a confirmation response to the assigned veteran status classification. The verification prompt 800 may further include a request for verification evidence. The verification prompt 800 may include an interaction element 812 that allows the user to upload, attach, or otherwise provide access to verification evidence and submit their responses as represented by operation 808.

Returning to FIG. 3, as shown by operation 318, the apparatus 200 includes means, such as memory 204, communications hardware 206, smart engine 208, or the like, for providing a veteran status notification. The veteran status notification may include the assigned veteran status classification determined for the user such that one or more end users may be made aware of the user's veteran status. In some embodiments, the veteran status notification further comprises verification evidence provided by the user. In some embodiments, the user may be visiting an establishment that offers benefits and/or services to veterans but may require proof of veteran status.

A user may provide proof of his/her veteran status via a veteran status notification, which may be provided in any suitable format. In some embodiments, the communications hardware 206 may provide a user device (e.g., any one of user devices 112A-112N) with the veteran status notification. The user may then use his/her user device (e.g., any one of user devices 112A-112N) to display the veteran status associated with a user account or profile. Thus, the user may share this display with one or more other users to prove his/her veteran status. Alternatively, in some embodiments, a veteran status notification may be provided to a user device (e.g., any one of user devices 112A-112N) and then the user device may subsequently provide the veteran status notification to another device (e.g., establishment device 114A-114N), such as via Bluetooth, near-field communication, over Wi-Fi, or over another communications network. In some embodiments, the communications hardware 206 may provide the veteran status notification directly to another device (e.g., establishment device 114A-114N).

FIGS. 3-7 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### CONCLUSION

As described above, example embodiments provide technical solutions designed to systematically identify the veteran status classification of a user. Such solutions have not previously been used, and are only achievable by harnessing the computational capabilities and widespread data accessibility offered by modern internet connectivity. Example embodiments allow establishments to automatically identify veterans without the need for manual inspection, and in a more robust and thorough fashion. Moreover, example embodiments save veteran identification time and resources in comparison to other possible approaches because they assign a veteran status classification only when deemed warranted by a trained veteran status predictive classification model. Overall, example embodiments thus enhance the process for the identifications of veterans, while eliminating the possibility of human error that would be otherwise unavoidable. Finally, by automating functionality that has historically required human analysis and judgement, the speed and consistency of the evaluations performed by example embodiments unlocks many potential new functions that have historically not been available, such as by identifying users or affiliate users for qualifying veteran offers in response to their real-time visit to an establishment, that could not historically be accounted for in any systematic fashion.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for automatic identification of veteran status, the method comprising:
extracting, by a smart engine and using a veteran status predictive classification model, user data from a data environment;
determining, by the smart engine and using the veteran status predictive classification model, a user attribute set based on the extracted user data, wherein (i) the user attribute set comprises one or more user attributes and (ii) each user attribute is associated with a user data type;
generating, by the smart engine and using the veteran status predictive classification model, an aggregated veteran likelihood score, wherein the aggregated veteran likelihood score is based on an analysis of the one or more user attributes from the user attribute set; and
in an instance in which the aggregated veteran likelihood score satisfies a predefined veteran likelihood threshold:
assigning, by the smart engine and using the veteran status predictive classification model, a veteran status classification to a user based on the aggregated veteran likelihood score, and
providing, by communications hardware and based on the assigned veteran status classification, a verification prompt, wherein the verification prompt requests the user to verify the assigned veteran status classification.

2. The method of claim 1, wherein extracting user data occurs in response to:
detecting, by user detection circuitry, a user visit event at an establishment, wherein the establishment is associated with at least one veteran status opportunity.

3. The method of claim 1, wherein determining the user attribute set comprises:
analyzing, by the smart engine and using the veteran status predictive classification model, a plurality of veteran status indicators from the extracted user data, wherein the one or more veteran status indicators comprise one or more of (i) financial data, (ii) address history, (iii) medical history, or (iv) familial relationships.

4. The method of claim 1, wherein generating the aggregated veteran likelihood score comprises:
determining, by the smart engine and using the veteran status predictive classification model, a plurality of per-veteran status indicator veteran likelihood scores, wherein (i) each per-veteran status indicator veteran likelihood score is determined based on an analysis of one or more veteran status indicators associated with a corresponding user data type, and (ii) the aggregated veteran likelihood score is generated based on the plurality of per-veteran status indicator veteran likelihood scores.

5. The method of claim 1, wherein providing a verification prompt occurs in response to:
determining, by the smart engine and using the veteran status predictive classification model, whether the veteran status classification assigned to the user qualifies for the at least one veteran status opportunity offered by the establishment; and
in an instance in which the veteran status classification assigned to the user qualifies for the at least one veteran status opportunity offered by the establishment,
the communications hardware is further configured to:
provide, a verification prompt, wherein the verification prompt indicates that the user qualifies for the at least one veteran status opportunity offered by the establishment.

6. The method of claim 1, further comprising:
receiving, by the communications hardware, a verification response to the verification prompt, wherein the verification response confirms or refutes the assigned veteran status classification; and
in an instance in which the veteran status classification is confirmed,
requesting, by communications hardware, verification evidence for the assigned veteran status classification;
determining, by an authentication engine, an authenticity score for the verification evidence; and
in an instance in which the authenticity score satisfies a predefined authenticity score threshold,
updating, by the smart engine, a veteran status of the user to the assigned veteran status classification.

7. The method of claim 6, in an instance in which the verification evidence satisfies the predefined authenticity score threshold for an affiliate user, further comprising:
determining, by the smart engine and using a veteran status predictive classification model, a familial veteran status classification for the affiliate user, wherein the familial veteran status classification is indicative of a relationship type between the affiliate user and the user; and
in an instance in which the familial veteran status classification for the affiliate user corresponds to a qualifying veteran status classification of the user,
updating, by the smart engine, a veteran status of the affiliate user to the familial veteran status classification.

8. The method of claim 1, further comprising:
training, by the smart engine and using a veteran status predictive classification model, the veteran status classification model based on (i) the one or more veteran status indicators from the user attribute set and predictive classification accuracy, wherein said predictive classification accuracy is determined by a historical confirmed or refuted response to the assigned veteran status classification for a plurality of users.

9. An apparatus for automatic identification of veteran status, the apparatus comprising:
a smart engine configured to:
extract, using a veteran status predictive classification model, user data from a data environment,
determine, using the veteran status predictive classification model, a user attribute set based on the extracted user data, wherein (i) the user attribute set comprises one or more user attributes and (ii) each user attribute is associated with a user data type,
generate, using the veteran status predictive classification model, an aggregated veteran likelihood score, wherein the aggregated veteran likelihood score is based on an analysis of one or more user attributes from the user attribute set, and
in an instance in which the aggregated veteran likelihood score satisfies a predefined threshold, assign, using the veteran status predictive classification model, a veteran status classification to the user based on the aggregated veteran likelihood score; and
communications hardware configured to, in the instance in which aggregated veteran likelihood score satisfies the predefined threshold, provide, based on the assigned veteran status classification, a verification prompt, wherein the verification prompt requests the user to verify the assigned veteran status classification.

10. The apparatus of claim 9, further comprising:
user detection circuitry configured to detect a user visit event at an establishment, wherein the establishment is associated with at least one veteran status opportunity.

11. The apparatus of claim 9, wherein the smart engine is further configured to:
analyze, using the veteran status predictive classification model, a plurality of veteran status indicators from the extracted user data, wherein the one or more veteran status indicators comprise one or more of (i) financial data, (ii) address history, (iii) medical history, or (iv) familial relationships.

12. The apparatus of claim 9, wherein the smart engine is further configured to:
determine, using the veteran status predictive classification model, a plurality of per-veteran status indicator veteran likelihood scores, wherein (i) each per-veteran status indicator veteran likelihood score is determined based on an analysis of one or more veteran status indicators associated with a corresponding user data type, and (ii) the aggregated veteran likelihood score is generated based on the plurality of per-veteran status indicator veteran likelihood scores.

13. The apparatus of claim 9,
wherein the smart engine is further configured to determine, using the veteran status predictive classification model, whether the veteran status classification assigned to the user qualifies for the at least one veteran status opportunity offered by the establishment,
wherein the communications hardware is further configured to, in an instance in which the veteran status classification assigned to the user qualifies for the at least one veteran status opportunity offered by the establishment, provide, a verification prompt, wherein the verification prompt indicates that the user qualifies for the at least one veteran status opportunity offered by the establishment.

14. The apparatus of claim 9, wherein the communications hardware is further configured to:
receive, a verification response to the verification prompt, wherein the verification response confirms or refutes the assigned veteran status classification; and
in an instance in which the veteran status is confirmed, request, verification evidence for the assigned veteran status classification,
wherein the apparatus further comprises an authentication engine configured to:
determine, an authenticity score for the verification evidence; and
in an instance in which the authenticity score satisfies a predefined authenticity score threshold,
wherein the smart engine is further configured to update a veteran status of the user to the assigned veteran status classification.

15. The apparatus of claim 14, wherein the smart engine is further configured to, in an instance in which the verification evidence satisfies the predefined authenticity score threshold for an affiliate user:
determine a familial veteran status classification for the affiliate user, wherein the familial veteran status classification is indicative of a relationship type between the affiliate user and the user;
determine whether the familial veteran status classification for the affiliate user corresponds to a qualifying veteran status classification; and
in an instance in which the familial veteran status for the affiliate user corresponds to a qualifying veteran status classification of the user,
update a veteran status of the affiliate user to the familial veteran status classification.

16. The apparatus of claim 9, wherein the smart engine is further configured to:
train, the veteran status classification model based on (i) the one or more veteran status indicators from the user attribute set and (ii) predictive classification accuracy, wherein said predictive classification accuracy is determined by a historical confirmed or refuted response to the assigned veteran status classification for a plurality of users.

17. A computer program product for automatic identification of veteran status, the computer program comprising at least one non-transitory computer readable storage medium storing software instructions that, when executed, cause an apparatus to:
extract, using a veteran status predictive classification model, user data from a data environment;
determine, using the veteran status predictive classification model, a user attribute set based on the extracted user data, wherein (i) the user attribute set comprises one or more user attributes and (ii) each user attribute is associated with a user data type;
generate, using the veteran status predictive classification model, an aggregated veteran likelihood score, wherein the aggregated veteran likelihood score is based on an analysis of one or more user attributes from the user attribute set; and
in an instance in which the aggregated veteran likelihood score satisfies a predefined threshold:
assign, using the veteran status predictive classification model, a veteran status classification to the user based on the aggregated veteran likelihood score, and
provide, based on the assigned veteran status classification, a verification prompt, wherein the verification prompt requests the user to verify the assigned veteran status classification.

18. The computer program product of claim 17, wherein the software instructions, when executed, further cause the apparatus to:
determine, using the veteran status predictive classification model, a plurality of per-veteran status indicator veteran likelihood scores, wherein (i) each per-veteran status indicator veteran likelihood score is determined based on an analysis of one or more veteran status indicators associated with a corresponding user data type, and (ii) the aggregated veteran likelihood score is generated based on the plurality of per-veteran status indicator veteran likelihood scores.

19. The computer program product of claim 17, wherein the software instructions, when executed, further cause the apparatus to:
determine, using the veteran status predictive classification model, whether the veteran status classification assigned to the user qualifies for the at least one veteran status opportunity offered by the establishment; and
in an instance in which the veteran status classification assigned to the user qualifies for the at least one veteran status opportunity offered by the establishment, provide a verification prompt, wherein the verification prompt indicates that the user qualifies for the at least one veteran status opportunity offered by the establishment.

20. The computer program product of claim 17, wherein the software instructions, when executed, further cause the apparatus to:
receive a verification response to the verification prompt, wherein the verification response confirms or refutes the assigned veteran status classification; and
in an instance in which the veteran status classification is confirmed:
request verification evidence for the veteran status classification;
determine an authenticity score for the verification evidence; and
in an instance in which the authenticity score satisfies a predefined authenticity score threshold, update a veteran status of the user to the assigned veteran status classification.
